(19) United States
(12) Patent Application Publication
(10) Pub. No.: US 2026/0356193 A1
(43) Pub. Date: Nov. 12, 2026

(54) DRIVING OPERATION APPARATUS FOR VEHICLE

(71) Applicants: Hyundai Motor Company, Seoul (KR); Kia Corporation, Seoul (KR); LS Automotive Technologies Co., Ltd., Anyang-si (KR)

(72) Inventors: Eun Sik KIM, Hwaseong-Si (KR); Ki Nyeong KO, Anyang-Si (KR); Jung Jae LEE, Anyang-si (KR)

(73) Assignees: Hyundai Motor Company, Seoul (KR); Kia Corporation, Seoul (KR); LS Automotive Technologies Co., Ltd., Anyang-si (KR)

(21) Appl. No.: 19/406,025

(22) Filed: Dec. 2, 2025

(30) Foreign Application Priority Data
May 12, 2025 (KR) 10-2025-0061535

(51) Int. Cl. B60K 35/10; B60K 26/02; B60K 35/22; B60K 35/65; B60Q 1/34; B60T 7/08; B60W 10/20; B60W 50/16; B60W 60/00; B62D 1/22; G05G 1/01

(52) U.S. Cl. CPC B60K 35/10; B60K 26/02; B60K 35/22; B60K 35/654; B60Q 1/346; B60T 7/085; B60W 10/20; B60W 50/16; B60W 60/005; B62D 1/22; G05G 1/01; B60K 2360/175; B60W 2710/20

(57) ABSTRACT

A driving operation apparatus for a vehicle, is configured so that first and second driving operation systems, operated by a driver for steering, acceleration, and braking, are integrated into a single system together with a display unit to form a module. As the first and second driving operation systems move in opposite vertical directions in an interlinked manner during a steering operation by the driver, it may be possible to ensure safety during the steering operation.

### CROSS-REFERENCE TO RELATED APPLICATIONS

The present application is based on and claims priority under 35 U.S.C. 119 to Korean Patent Application No. 10-2025-0061535, filed on May 12, 2025, the present disclosure of which is herein incorporated by reference in its entirety.

### BACKGROUND OF THE PRESENT DISCLOSURE

### Field of the Present Disclosure

Embodiments included herein relate to a driving operation apparatus for a vehicle. More particularly, the embodiments relate to a driving operation apparatus for a vehicle in which driving operation systems for steering, acceleration, and braking are integrated into a single system together with a display to form a module.

### Description of Related Art

A self-driving vehicle is a smart vehicle incorporating autonomous driving technology that allows it to independently navigate to a destination without requiring the driver to manually operate the steering wheel, accelerator pedal, or brake.

When autonomous driving is widely implemented, it may be possible to select between a manual driving mode, in which the driver operates the vehicle directly, and an autonomous driving mode, in which the vehicle drives itself to the destination without driver intervention.

A driving operation system of a self-driving vehicle may typically include a steering operation system, an acceleration operation system, and a braking operation system. A general driving operation system is configured so that the operation systems for steering, acceleration, and braking are each provided separately. As a result, the number of components increases, separate installation spaces are required, and there are significant spatial constraints. In particular, costs may increase.

The foregoing described as the background art is intended merely to aid in the understanding of the background of embodiments set forth herein, and should not be construed as meaning that the embodiments fall within the purview of the related art already known to those skilled in the art.

### BRIEF SUMMARY

In various aspects of the present disclosure, the present disclosure is to provide a driving operation apparatus for a vehicle, in which first and second driving operations, operated by the driver for steering, acceleration, and braking, are integrated into a single system together with a display unit to form a module, allowing for a reduction in the number of components, which in turn enables weight reduction and cost savings, and minimizing the layout required for installation space to maximize the utilization of internal space.

In various aspects of the present disclosure, the present disclosure is to provide a driving operation apparatus, which is configured so that first and second driving operation systems move in opposite vertical directions in an interlinked manner during a steering operation by a driver, ensuring safety during the steering operation.

In various aspects of the present disclosure, the present disclosure is to provide a driving operation apparatus, which is configured so that in an autonomous driving situation, the movement of first and second driving operation systems, which are driven vertically by a motor, allows a driver to easily recognize that steering control of the vehicle is being smoothly performed in the autonomous driving mode, providing passengers with a sense of stability during autonomous driving.

The technical subjects pursued in embodiments set forth herein may not be limited to the above-mentioned technical subjects, and other technical subjects which are not mentioned herein may be clearly understood from the following description by those skilled in the art to which the embodiments pertain.

In view of the foregoing, in various aspects of the present disclosure, a driving operation apparatus for vehicle includes: a case module fixedly provided while being connected to a vehicle panel unit; first and second driving operation systems respectively disposed on left and right sides of the case module to be connected to the case module and configured to vertically move with respect to the case module and to allow a driver to perform steering, acceleration, and braking operations; and a steering module disposed in the case module and configured to generate a signal related to a steering function when a steering operation is performed using the first and second driving operation systems.

A panel extension is fixedly coupled to the vehicle panel unit, and the case module is fixedly coupled to the panel extension. By the panel extension, a clearance space is ensured between the vehicle panel unit and the first driving operation system and between the vehicle panel unit and the second driving operation system, allowing a driver’s hands to enter the clearance space to hold the first and second driving operation systems.

The driving operation apparatus further includes a display unit coupled to a rear surface of the case module facing the driver.

The first and second driving operation systems are configured to move in opposite vertical directions to each other.

From the driver’s perspective, the first and second driving operation systems are disposed on left and right sides of the case module, respectively. In a manual driving mode, when the first and second driving operation systems are located at a neutral position without moving vertically, the steering module is configured to generate a straight-driving signal. In the manual driving mode, when the first driving operation system moves downward and the second driving operation system moves upward, the steering module is configured to generate a left-turn signal. In the manual driving mode, when the first driving operation system moves upward and the second driving operation system moves downward, the steering module is configured to generate a right-turn signal.

Guide grooves are disposed on the left and right sides of the case module to extend in the vertical direction along which the first and second driving operation systems move, and the first and second driving operation systems respectively include protrusions that are engaged into and move along the guide grooves.

The steering module includes: a gear unit rotatably disposed in the case module, engaged with the first and second driving operation systems, and configured with an odd number of gears engaged with each other so that the first and second driving operation systems move in opposite vertical directions to each other; a first permanent magnet coupled to the gear unit; and a first PCB coupled to the case module to face the first permanent magnet, and configured to detect a change in magnetic flux of the first permanent magnet during the steering operation of the driver and generate a signal related to a steering function.

The driving operation apparatus further includes a steering return spring disposed with opposite end portions thereof connected to the case module and the gear unit to accumulate elastic force as the gear unit rotates during the steering operation and to return the rotated gear unit and the first and second driving operation systems connected thereto to a neutral position when a steering operation force is released.

The driving operation apparatus further includes a motor coupled to one of the gears forming the gear unit. In an autonomous driving mode, when the vehicle automatically performs steering control, a vehicle autonomous driving controller is configured for transmitting a steering signal corresponding to the steering control to a driving operation system controller. The driving operation system controller is configured for transmitting a motor drive signal in proportion to the steering signal to the motor. The first and second driving operation systems move vertically as the gear unit rotates by driving of the motor. Information indicating that steering control is being performed is provided to the driver in the autonomous driving mode through the vertical movement of the first and second driving operation systems.

From the driver’s perspective, the first and second driving operation systems are disposed on left and right sides of the case module, respectively. In the autonomous driving mode, when the first and second driving operation systems remain at a neutral position without moving vertically, the vehicle is in a straight-driving state. In the autonomous driving mode, when the motor is driven to move the first driving operation system downward and the second driving operation system upward, the vehicle is in a left-turn driving state. In the autonomous driving mode, when the motor is driven to move the first driving operation system upward and the second driving operation system downward, the vehicle is in a right-turn driving state.

When an autonomous driving disable condition occurs in the autonomous driving mode, the motor is driven to alternately perform clockwise and counterclockwise rotations in succession, and when the first and second driving operation systems receive a driving force from the motor and continuously move in the vertical direction, the vehicle is in a state in which autonomous driving is not available.

The first and second driving operation systems respectively include operation system gears and that are engaged with the steering module so that when the steering module operates, the first and second driving operation systems interlink with each other and move in opposite vertical directions.

Each of the first and second driving operation systems includes: a handle portion including an operation system gear, which is engaged with the steering module and extends in the vertical direction, the handle portion being configured to be held by the driver’s hand; and handle covers coupled to upper and lower end portions of the handle portion. Each of the handle covers includes cover protrusions that protrude outward to prevent the driver’s hand from slipping off the handle portion.

Each of the first and second driving systems may further include a handle portion connected to the steering module and configured to be held by the driver; a switch unit disposed on each handle portion to protrude outwardly from the handle portion, operated by a finger of the driver who holds the handle portion, and configured to move vertically along the handle portion during operation by the driver; a slider located inside the handle portion, coupled to the switch unit, and configured to move vertically along the handle portion together with the switch unit; a second permanent magnet coupled to the slider; and a second PCB, disposed in the handle portion to face the second permanent magnet and configured to detect a change in magnetic flux of the second permanent magnet when the switch unit is operated by the driver, and to generate a signal related to an acceleration function or a signal related to a braking function.

The slider includes slider rods that protrude vertically along the movement direction of the slider, and the handle portion includes rod insertion grooves into which the slider rods are respectively inserted and which guide the movement of the slider rods.

The driving operation apparatus further includes switch return springs, each of which is disposed with opposite end portions thereof supported by the slider and the handle portion. The switch return springs are configured to accumulate elastic force when the slider is moved by operation of the switch unit, and to return the moved slider and the switch unit to a neutral position when the operation force applied to the switch unit is released.

The second PCB is configured to generate one of the signal related to the acceleration function and the signal related to the braking function when the switch unit moves upward along the handle portion, and to generate a remaining one of the signals when the switch unit moves downward along the handle portion.

In various aspects of the present disclosure, a driving operation apparatus for a vehicle includes: a case module disposed to be connected to a vehicle panel unit; first and second driving operation systems disposed on left and right sides of the case module to be connected thereto to be movable in a vertical direction relative to the case module, and configured so that when one is operated, a remaining one moves in an opposite vertical direction to each other; and a switch unit disposed in each of the first and second driving operation systems and configured to slide vertically in response to a driver’s operation. When the first and second driving operation systems move in the vertical direction, a signal related to a steering function is generated, and when the switch unit moves in response to the driver’s operation, a signal related to an acceleration function or a signal related to a braking function is generated.

In a manual driving mode, when the driver moves the first and second driving operation systems in the vertical direction, a signal related to a steering function is generated.

The first and second driving operation systems move vertically by receiving power from a motor, and when the first and second driving operation systems are moved by driving of the motor in an autonomous driving mode, the driver may recognize that steering control is being performed in an autonomous driving situation.

A driving operation apparatus for a vehicle in various aspects of the present disclosure is a vehicle driving operation apparatus in which first and second driving operation systems, which are operated by the driver for steering, acceleration, and braking, are integrated into a single system together with a display unit to form a module, allowing for a reduction in the number of components, which in turn enables weight reduction and cost savings, and minimizing the layout required for installation space. As a result, it may be possible to maximize the utilization of internal space.

Furthermore, in various aspects of the present disclosure, the first and second driving operation systems are configured to move in opposite vertical directions to each other during a steering operation by the driver. As a result, it may be possible to ensure safety during the steering operation.

Furthermore, in various aspects of the present disclosure, the first and second driving operation systems, which are driven in the vertical direction by the motor in an autonomous driving situation, are configured to allow the driver to easily recognize, through the vertical movements thereof, that steering control of the vehicle is being smoothly performed in the autonomous driving mode. As a result, it may be possible to provide a sense of stability to passengers during the autonomous driving mode.

Advantageous effects obtainable from embodiments set forth herein may not be limited to the above-mentioned effects, and other effects which are not mentioned herein may be clearly understood from the following description by those skilled in the art to which the embodiments pertain.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a view exemplarily illustrating a driving operation apparatus according to an exemplary embodiment included herein, which is coupled to a vehicle panel unit;

FIG. 2 is a view exemplarily illustrating the driving operation apparatus as separated from the vehicle panel unit illustrated in FIG. 1;

FIG. 3 is a plan view of FIG. 1;

FIG. 4 is an exploded view of the driving operation apparatus; and

FIGS. 5, 6, 7, 8, 9, 10, 11, 12, 13, 14, 15, 16, and 17 are views exemplarily illustrating the configuration of the driving operation apparatus.

### DETAILED DESCRIPTION

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure. The following descriptions are not intended to limit the present disclosure to the described form or specific field, and it is considered that various alternative modifications and changes may be made to the present disclosure regardless of whether the descriptions are explicit or implicit. Those skilled in the art to which the present disclosure pertains will appreciate that the contents of the present disclosure may be changed in forms and details.

The present disclosure will be described with reference to exemplary embodiments. However, as understood by a person ordinarily skilled in the art to which the present disclosure pertains, various aspects disclosed herein may be modified or otherwise implemented in different ways without departing from the spirit and scope of the present disclosure. Accordingly, the following description is to be considered exemplary, and is intended to teach those ordinarily skilled in the art to which the present disclosure belongs how to make and use various embodiments. It is to be understood that the forms of the present disclosure illustrated and described herein are exemplary embodiments. Equivalent elements, materials, processes, or steps may be substituted for those exemplified and described in the present disclosure. Expressions used in the present disclosure, such as “including,” “comprising,” “incorporating,” “consisting of,” “have,” or “is,” should be interpreted in a non-exclusive manner, i.e., to allow for the inclusion of items, components, or elements not explicitly listed. In addition, references to the singular form should be interpreted to include the plural form as well.

Furthermore, the various embodiments included herein should be regarded as exemplary and descriptive, and should not be construed as limiting the scope of the present disclosure. All references to joining (e.g., attached, affixed, coupled, and connected) are used solely to facilitate understanding of the present disclosure and are not intended to limit the position, orientation, or use of any component or method included herein. Accordingly, references to joining should be interpreted broadly. Moreover, these references to joining do not imply that two or more elements are directly connected to each other. Furthermore, all numerical terms, such as “first,” “second,” “third,” “primary,” “secondary,” “main,” or any other generic terms or numerical expressions, are to be understood solely as identifiers to aid in the understanding of the various components, embodiments, modifications, or variations of the present disclosure, and do not imply any limitations as to any component, embodiment, modification, variation, or their order or preference. That is, these terms may be used to describe various components but should not be construed as limiting the components to those terms. These terms are used only to distinguish one component from another.

The terms "module" and "unit" used for the elements in the following description are given or interchangeably used in consideration of only the ease of writing the specification, and do not have distinct meanings or roles by themselves.

In the case where an element is referred to as being "connected" or "coupled" to any other elements, it should be understood that not only the element may be directly connected or coupled to the other elements, but also another element may exist therebetween. Contrarily, in the case where an element is referred to as being "directly connected" or "directly coupled" to any other element, it should be understood that no other element exists therebetween.

Furthermore, a unit or a control unit included in names is merely a term widely used for naming a controller configured to control a predetermined function of a vehicle, but does not mean a generic function unit.

To control functions in charge, a controller may include a communication device configured to communicate with a sensor or another controller, a memory configured to store an operating system or logic instructions and input/output information, and at least one processor configured to perform determination, calculation, decision, or the like required for control of the functions in charge.

Any number or variety of components in any of the configurations described herein may be included within the scope of the present disclosure described herein. The components may include any combination of the features described herein and may be arranged in any of the various configurations described herein. The concepts related to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

Hereinafter, various embodiments set forth herein will be described in detail with reference to the accompanying drawings, and the same or similar elements are provided the same and similar reference numerals regardless of figure numbers, so duplicate descriptions thereof will be omitted.

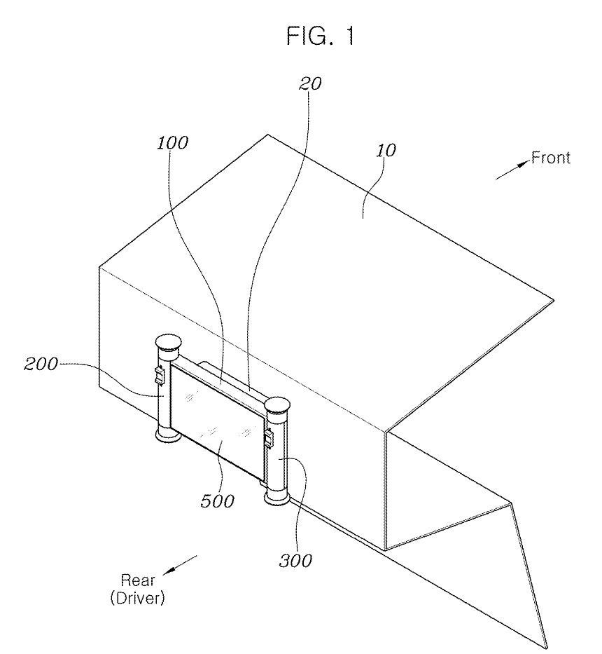

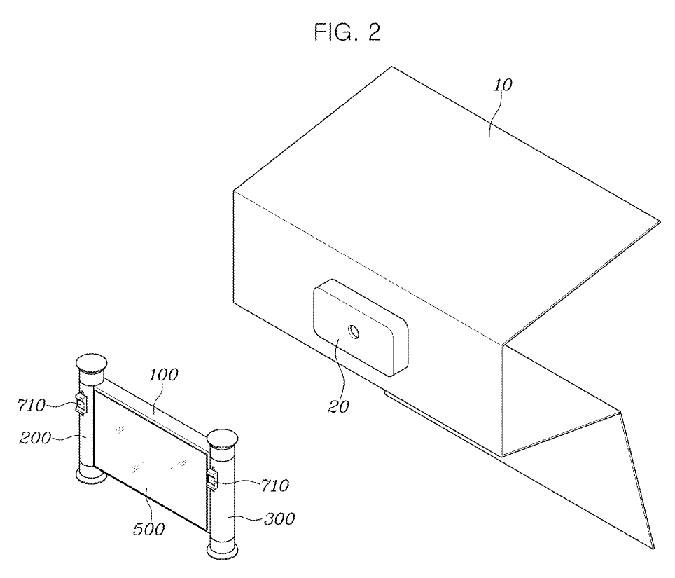

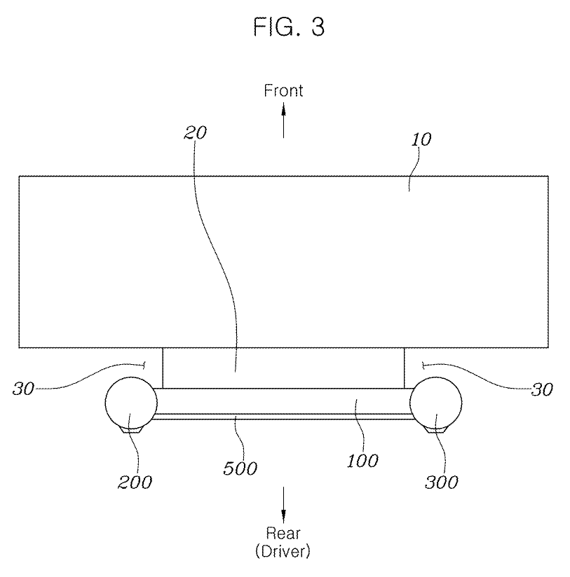

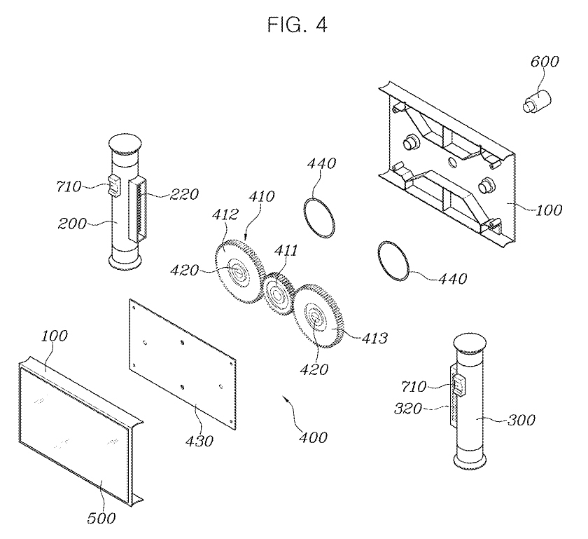

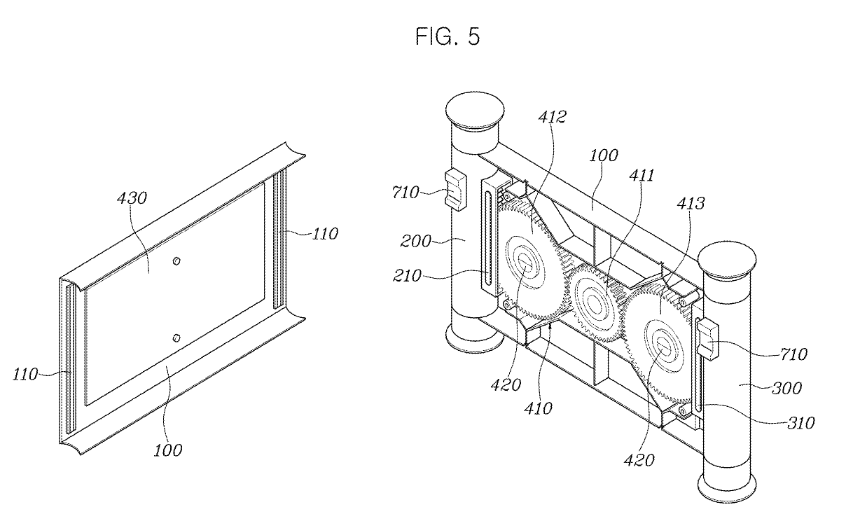

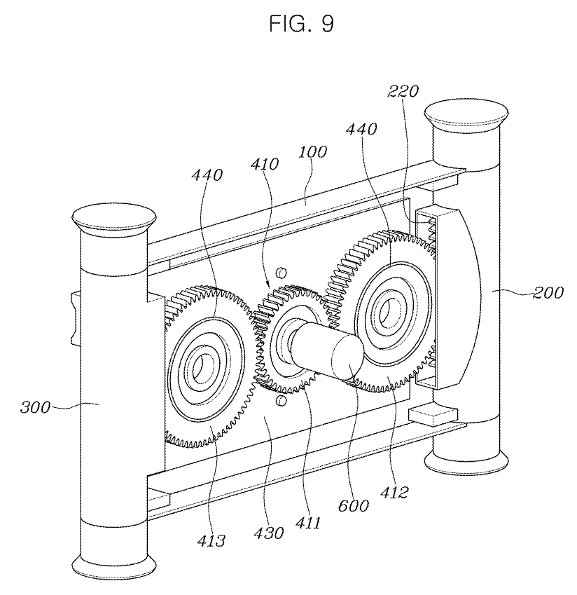

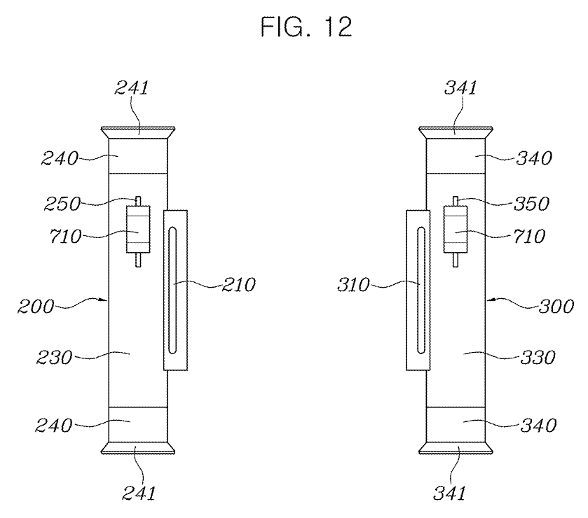

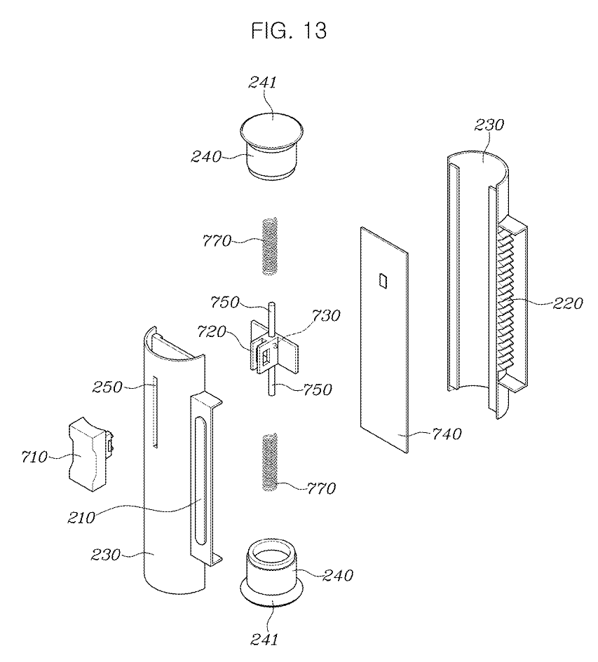

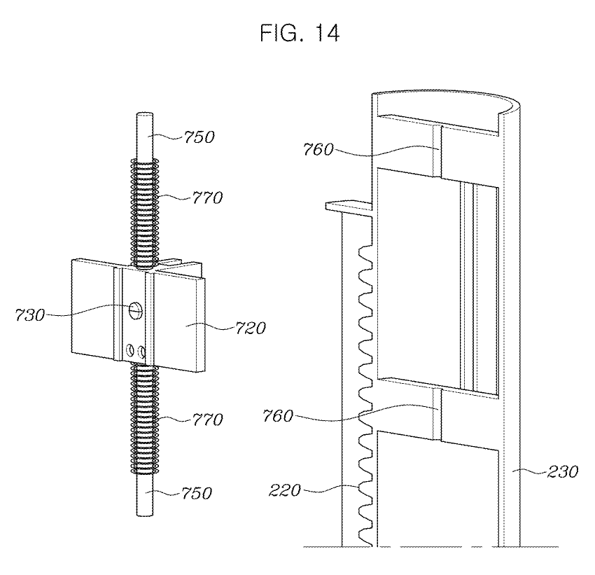

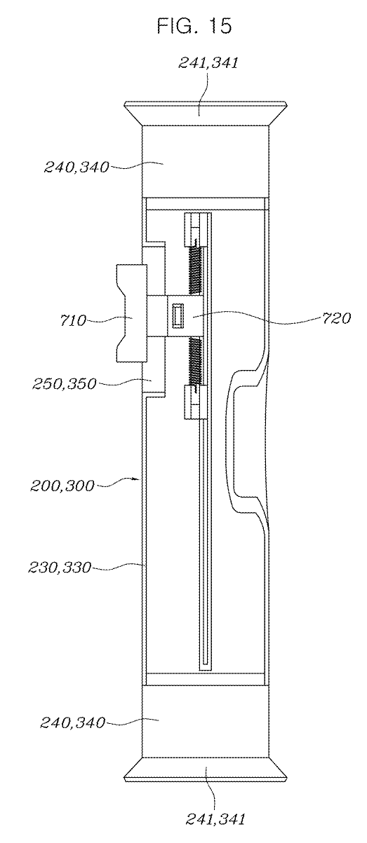

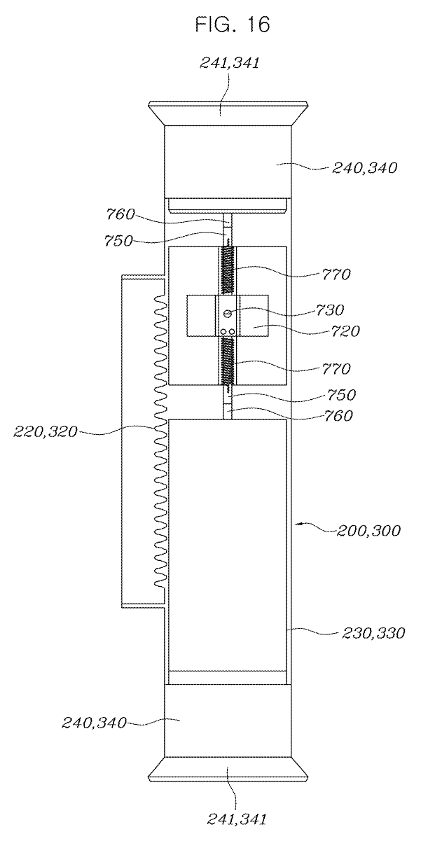

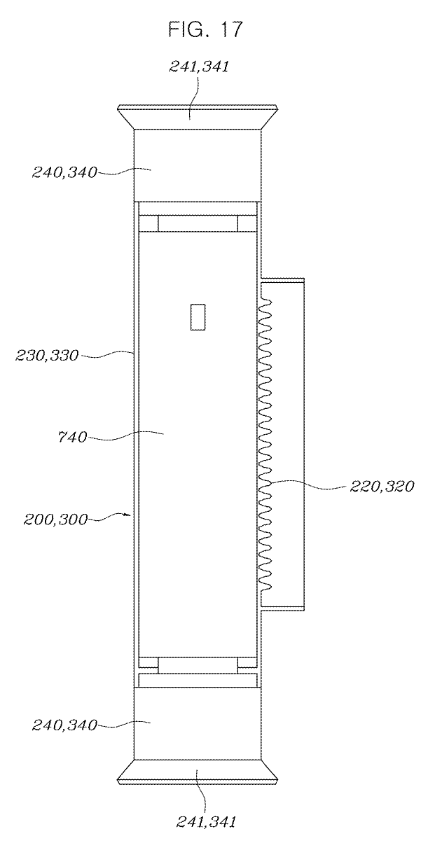

As illustrated in FIGS. 1-17, according to an exemplary embodiment included herein, a driving operation apparatus for a vehicle may include: a case module 100 fixedly disposed while being connected to a vehicle panel unit 10; first and second driving operation systems 200 and 300 respectively disposed on the left and right sides of the case module 100 to be connected thereto and configured to vertically move with respect to the case module 100 and to allow a driver to perform steering, acceleration, and braking operations; a steering module 400 disposed in the case module 100 and configured to generate a signal related to a steering function when a steering operation is performed using the first and second driving operation systems 200 and 300; and a display unit 500 coupled to a rear surface of the case module 100 facing the driver.

The vehicle panel unit 10 may be a center fascia disposed in the vehicle interior, but is not limited thereto.

In the case module 100, the first and second driving operation systems 200 and 300 may be disposed to be connected to left and right edge portions of the case module 100, respectively, and the driver may hold the first and second driving operation systems 200 and 300 to perform steering, acceleration, and braking operations.

The display unit 500 may be disposed to face the driver to provide various information to the driver and passengers.

In a manual driving mode, the display unit 500 may provide vehicle information and surrounding information, and in an autonomous driving mode, the display unit 500 may provide entertainment-related information.

A panel extension 20 may be fixedly coupled to the vehicle panel unit 10 in a direction facing the driver, and the case module 100 may be fixedly coupled to the panel extension 20.

The panel extension 20 may be formed as a hexahedral structure having a predetermined thickness, and when coupled to the vehicle panel unit 10, the panel extension 20 may protrude rearward toward the driver.

The vehicle panel unit 10 and the case module 100 may be connected via the panel extension 20.

When the panel extension 20 is coupled to the vehicle panel unit 10 and the case module 100 is coupled to the panel extension 20, a clearance space 30 may be ensured between the vehicle panel unit 10 and the first driving operation system 200 and between the vehicle panel unit 10 and the second driving operation system 300, allowing the driver’s hands to enter the clearance space to hold the first and second driving operation systems 200 and 300. Through the clearance space 30, the driver may more easily hold the first and second driving operation systems 200 and 300.

The driver may hold the first and second driving operation systems 200 and 300 with his or her hands and perform a steering operation by moving the first and second driving operation systems 200 and 300 vertically.

According to an exemplary embodiment included herein, the first and second driving operation systems 200 and 300 may be configured to interlink with each other and to move in opposite vertical directions.

When the first driving operation system 200 moves upward, the second driving operation system 300 may move downwardly in conjunction with the first driving operation system 200, and when the first driving operation system 200 moves downward, the second driving operation system 300 may move upward in conjunction with the first driving operation system 200.

Accordingly, the driver may perform the steering operation by simultaneously moving the first and second driving operation systems 200 and 300 in opposite vertical directions, or by moving only one of the first and second driving operation systems 200 and 300 vertically.

Since the first and second driving operation systems 200 and 300 move in opposite vertical directions during the steering operation, a steering feel similar to that of manipulating a conventional circular steering wheel may be achieved.

From the driver’s perspective, the first and second driving operation systems 200 and 300 may be disposed on the left and right sides of the case module 100, respectively.

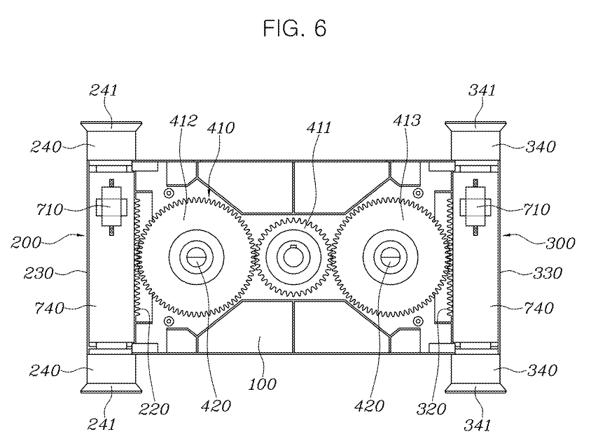

Referring to FIG. 6, in the manual driving mode, when the first and second driving operation systems 200 and 300 are located at a neutral position without moving vertically, the steering module 400 may generate a straight-driving signal.

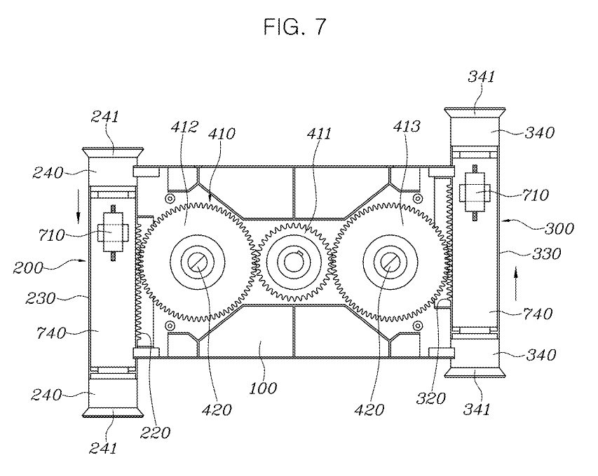

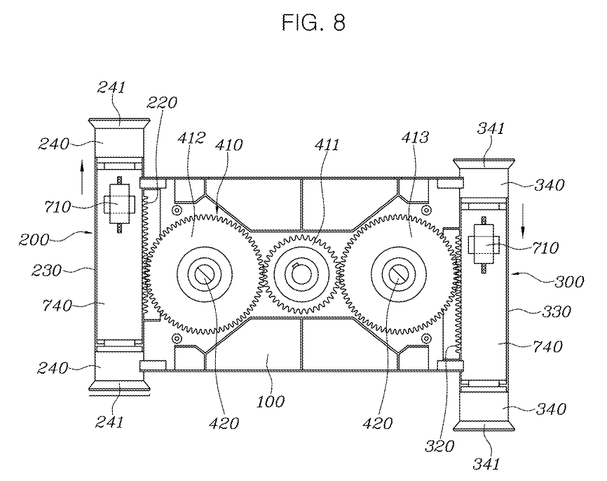

Referring to FIG. 7, in the manual driving mode, when the first driving operation system 200 moves downward and the second driving operation system 300 moves upward, the steering module 400 may generate a left-turn signal. Referring to FIG. 8, in the manual driving mode, when the first driving operation system 200 moves upward and the second driving operation system 300 moves downward, the steering module 400 may generate a right-turn signal.

The first and second driving operation systems 200 and 300 may be disposed on the left and right sides of the case module 100 while being connected thereto, and may move vertically relative to the case module 100 during the steering operation by the driver.

To the present end, guide grooves 110 may be formed on the left and right sides of the case module 100 to extend in the vertical direction along which the first and second driving operation systems 200 and 300 move. The first and second driving operation systems 200 and 300 may include protrusions 210 and 310 that are engaged into and move along the guide grooves 110.

The vertical lengths of guide grooves 110 may be respectively longer than the vertical lengths of the corresponding protrusions 210 and 310, allowing the protrusions 210 and 310 to move smoothly along the guide grooves 110.

When the first and second driving operation systems 200 and 300 move in the vertical direction, the protrusions 210 and 310 may move until they come into contact with the guide grooves 110, which may act as a full stroke in the vertical movement of the first and second driving operation systems 200 and 300.

The steering module 400 according to an exemplary embodiment included herein may include: a gear unit 410 rotatably disposed in the case module 100, engaged with the first and second driving operation systems 200 and 300, and configured with an odd number of gears engaged with each other so that the first and second driving operation systems 200 and 300 interlink in opposite vertical directions; a first permanent magnet 420 coupled to the gear unit 410; a first PCB 430 coupled to the case module 100 to face the first permanent magnet 420, and configured to detect a change in magnetic flux of the first permanent magnet 420 during the steering operation by the driver and generate a signal related to a steering function; and a steering return spring 440 disposed with opposite end portions thereof connected to the case module 100 and the gear unit 410 to accumulate elastic force as the gear unit 410 rotates during the steering operation and to return the rotated gear unit 410 and the first and second driving operation systems 200 and 300 connected thereto to a neutral position when a steering operation force is released.

The gear unit 410 may include a structure in which a plurality of gears are engaged with each other, and the plurality of gears may be configured with an odd number of gears.

For example, the gear unit 410 may include a first gear 411, a second gear 412, and a third gear 413, and the first gear 411 is configured as a center gear positioned between the second gear 412 and the third gear 413.

The second and third gears 412 and 413 may be connected in an engaged structure with the first and second driving operation systems 200 and 300, respectively.

Accordingly, the second gear 412 and the third gear 413 may always rotate in the same direction (clockwise or counterclockwise), and as a result, the first and second driving operation systems 200 and 300 may interlink with each other and move in opposite directions.

A plurality of first permanent magnets 420 may be disposed and fixedly coupled to center portions of the second gear 412 and the third gear 413. The first PCB 430 may be fixedly coupled to the case module 100 while facing the first permanent magnet 420.

The first PCB 430 may include a non-contact sensor configured for detecting a change in magnetic flux of the first permanent magnet 420, and the non-contact sensor may include a Hall sensor.

Furthermore, the first PCB 430 may include a processor and be further configured to control the operation of the display unit 500.

A plurality of steering return springs 440 may be disposed to ensure stable return of the first and second driving operation systems 200 and 300.

That is, one of the steering return springs 440 may be disposed with opposite end portions thereof connected to the case module 100 and the second gear 412, and another steering return spring 440 may be disposed with opposite end portions thereof connected to the case module 100 and the third gear 413.

During a steering operation by the driver, the first and second driving operation systems 200 and 300 may move vertically, and the gear unit 410 may rotate as the first and second driving operation systems 200 and 300 move. As the gear unit 410 rotates, the steering return springs 440 may be compressed or extended to accumulate elastic force.

When the driver’s steering operation is released from the first and second driving operation systems 200 and 300, the gear unit 410 and the first and second driving operation systems 200 and 300 may rotate in the opposite direction by the spring force of the steering return springs 440 and return to a neutral position.

According to an exemplary embodiment included herein, the driving operation apparatus may further include a motor 600 coupled to one of the gears forming the gear unit 410.

The motor 600 may be fixedly disposed in the case module 100 and connected to the first gear 411 to transmit rotational power to the first gear 411.

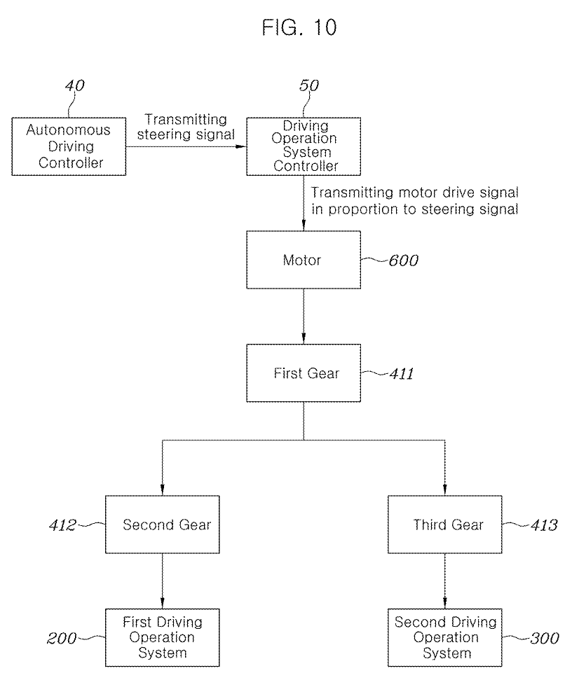

Referring to FIGS. 10 -11, in an autonomous driving mode, when the vehicle automatically performs steering control, a vehicle autonomous driving controller 40 may transmit a steering signal corresponding to the steering control to a driving operation system controller 50, and the driving operation system controller 50 may transmit a motor drive signal corresponding to the steering signal to the motor 600.

The driving force of the motor 600 may be transmitted to the first gear 411 of the gear unit 410 to rotate the first gear 411. As the first gear 411 rotates, the second gear 412 and the third gear 413 may simultaneously rotate in the same direction (clockwise or counterclockwise), and the first and second driving operation systems 200 and 300 may interlink with each other and move in opposite directions.

In the autonomous driving mode, the vertical movement of the first and second driving operation systems 200 and 300 represents information indicating that steering control is being smoothly performed in accordance with the traveling direction of the vehicle. The driver may recognize, through the vertically moving first and second driving operation systems 200 and 300, that steering control is being smoothly executed in the autonomous driving mode.

Furthermore, the vertical movement amounts of the first and second driving operation systems 200 and 300 in the autonomous driving mode may be considered to be proportional to the steering angle. Accordingly, the greater the vertical movements of the first and second driving operation systems 200 and 300, the greater the steering rotation angle of the vehicle. When the first and second driving operation systems 200 and 300 move to their maximum positions, the vehicle may make a U-turn.

For example, in the autonomous driving mode, when the first and second driving operation systems 200 and 300 remain in a neutral position without moving vertically, the vehicle may be in a straight-driving state. In the autonomous driving mode, when the motor 600 is driven to move the first driving operation system 200 downward and the second driving operation system 300 upward, the vehicle may be in a left-turn driving state. In the autonomous driving mode, when the motor 600 is driven to move the first driving operation system 200 upward and the second driving operation system 300 downward, the vehicle may be in a right-turn driving state.

Accordingly, in the autonomous driving mode, the driver may easily recognize whether the vehicle is in a straight-driving state, a right-turn driving state, or a left-turn driving state based on the vertical movements of the first and second driving operation systems 200 and 300, providing a sense of stability to the driver or passenger during autonomous driving mode.

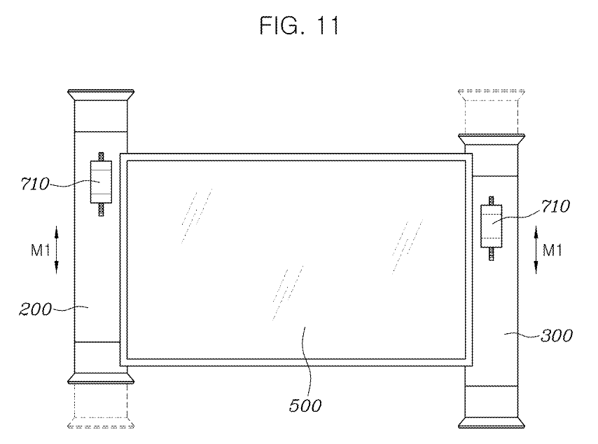

Furthermore, according to an exemplary embodiment included herein, when an autonomous driving disable condition occurs in the autonomous driving mode, the motor 600 may be driven to alternately perform clockwise and counterclockwise rotations in succession. The first and second driving operation systems 200 and 300 may receive the driving force from the motor 600 and continuously move in the vertical direction, as indicated by arrows M1 in FIG. 11. At the instant time, the vehicle is in a state in which autonomous driving is not available, and the driver may easily recognize the autonomous driving disable state through the continuously vertically moving first and second driving operation systems 200 and 300.

The autonomous driving disable state may include situations such as a situation where an autonomous driving sensor is broken, a situation where the vehicle and the autonomous driving sensor are contaminated and cannot function, a situation where the autonomous driving sensor cannot operate due to bad weather, and a situation where autonomous driving is not possible on an unpaved road.

The first and second driving operation systems 200 and 300 may be engaged with the gear unit 410 forming the steering module 400 and may move in the vertical direction of the case module 100 in response to the steering operation by the driver. The first and second driving operation systems 200 and 300 may interlink with each other and move in opposite vertical directions.

To the present end, the first and second driving operation systems 200 and 300 may respectively include operation system gears 220 and 320 that are engaged with the gear unit 410 of the steering module 400.

On one side of the first driving operation system 200, an operation system gear 220 may be disposed to extend in the longitudinal direction of the first driving operation system 200, and on one side of the second driving operation system 300, an operation system gear 320 may be disposed to extend in the longitudinal direction of the second driving operation system 300.

The operation system gear 220 of the first driving operation system 200 may be engaged with the second gear 412, and the operation system gear 320 of the second driving operation system 300 may be engaged with the third gear 413.

Each of the first and second driving operation systems 200 and 300 may include: a handle portion 230 or 330 including an operation system gear 220 or 320, which is engaged with the steering module 200 and extends in the vertical direction, the handle portion being configured to be held by the driver’s hand; and handle covers 240 or 340 coupled to upper and lower end portions of the handle portion 230 or 330.

The handle portion 230 or 330 may be formed in a cylindrical shape that allows the driver to easily hold the handle portion by hand, and the handle covers 240 or 340 may be respectively coupled to upper and lower end portions of the handle portion 230 or 330.

Each of the handle covers 240 or 340 may be disposed with a cover protrusion 241 or 341 that protrudes outward to prevent the driver’s hand from slipping off the handle portion 230 or 330.

The driver may perform a steering operation by vertically moving the first and second driving operation systems 200 and 300 while holding the handle portions 230 and 330 of the first and second driving operation systems 200 and 300.

As there is a concern that the driver’s hands may slip off the handle portions 230 and 330 during the steering operation, the cover protrusions 241 and 341 are formed to protrude outward at the end portions of the handle covers 240 and 340 to prevent the driver’s hands from slipping off the handle portions 230 and 330.

According to an exemplary embodiment included herein, each of the first and second driving operation systems may further include: a switch unit 710 disposed on each handle portion 230 or 330 to protrude outwardly from the handle portion 230 or 330, operated by a finger of the driver who holds the handle portion 230 or 330, and configured to move vertically along the handle portion 230 or 330 during operation by the driver; a slider 720 located inside the handle portion 230 or 330, coupled to the switch unit 710, and configured to move vertically along the handle portion 230 or 330 together with the switch unit 710; a second permanent magnet 730 coupled to the slider 720; and a second PCB 740 including a processor, disposed in the handle portion 230 or 330 to face the second permanent magnet 730 and configured to detect a change in magnetic flux of the second permanent magnet 730 when the switch unit 710 is operated by the driver, and to generate a signal related to an acceleration function or a function related to a braking function.

The slider 720, to which the switch unit 710 and the second permanent magnet 730 are coupled, and the second PCB 740 may be identically configured in each of the first and second driving operation systems 200 and 300.

The slider 720 coupled with the second permanent magnet 730 and the second PCB 740 may be disposed to be located inside each of the handle portions 230 and 330, and the switch unit 710 may be disposed to protrude outwardly from each of the handle portions 230 and 330 while being coupled to the slider 720.

The driver may perform a steering operation by holding the handle portions 230 and 330 with the hands, and may perform an acceleration or braking operation by moving the switch unit 710 vertically with a thumb while holding the handle portions 230 and 330.

A switch mounting hole 250 or 350 may be formed in each of the handle portions 230 and 330 to extend in the vertical direction in which the switch unit 710 moves, to allow vertical movement of the switch unit 710.

The second permanent magnet 730 may be fixedly coupled to the slider 720, and the second PCB 740 may be fixedly coupled to the handle portion 230 or 330 to face the second permanent magnet 730.

The second PCB 740 may include a non-contact sensor configured to detect a change in magnetic flux of the second permanent magnet 730, and the non-contact sensor may include a Hall sensor.

The switch unit 710 and the slider 720 may be coupled to each other so that, when the driver operates the switch unit 710, the switch unit 710 and the slider 720 move together in the vertical direction thereof.

To enable vertical movement of the slider 720, the slider 720 may include slider rods 750 that protrude vertically along the movement direction of the slider 720, and the handle portion 230 or 330 may include rod insertion grooves 760 into which the slider rods 750 are respectively inserted and which guide the movement of the slider rods 750.

According to an exemplary embodiment included herein, the driving operation apparatus may further include switch return springs 770, each of which is disposed with opposite end portions thereof supported by the slider 720 and the handle portion 230 or 330. The switch return springs 770 are configured to accumulate elastic force when the slider 720 is moved by operation of the switch unit 710, and to return the moved slider 720 and the switch unit 710 to a neutral position when the operation force applied to the switch unit 710 is released.

The slider rods 750 may be disposed to protrude vertically from the slider 720, and the switch return springs 770 may be respectively coupled to the vertically protruding slider rods 750 so that one end portion of each switch return spring 770 is supported by the handle portion 230 or 330 and the other end portion thereof is supported by the slider 720.

As the driver operates the switch unit 710, when the slider 720 moves upward or downward, the switch return springs 770 may be compressed or extended to accumulate elastic force, and when the driver’s operation force applied to the switch unit 710 is released, the slider 720 and the switch unit 710 may move in the opposite direction by the spring force of the switch return springs 770 and return to a neutral position.

The second PCB 740 may be configured to generate one of a signal related to an acceleration function and a signal related to a braking function when the switch unit 710 moves upward along the handle portion 230 or 330, and to generate a remaining one of the signals when the switch unit 710 moves downward along the handle portion 230 or 330.

For example, when the switch unit 710 moves upward along the handle portion 230 or 330, a signal related to the acceleration function may be generated, and when the switch unit 710 moves downward, a signal related to the braking function may be generated.

Conversely, when the switch unit 710 moves upward along the handle portion 230 or 330, a signal related to the braking function may be generated, and when the switch unit moves downward, a signal related to the acceleration function may be generated.

According to an exemplary embodiment included herein, a driving operation apparatus for a vehicle may include: a case module 100 disposed to be connected to a vehicle panel unit 10; first and second driving operation systems 200 and 300 disposed on left and right sides of the case module 100 to be connected thereto to be movable in a vertical direction relative to the case module 100, and configured so that when one is operated, the other moves in an opposite vertical direction in an interlinked manner; and a switch unit 710 disposed in each of the first and second driving operation systems 200 and 300 and configured to slide vertically in response to a driver’s operation. When the first and second driving operation systems 200 and 300 move in the vertical direction, a signal related to a steering function may be generated, and when the switch unit 710 moves by the driver’s operation, a signal related to an acceleration function or a signal related to a braking function may be generated.

In a manual driving mode, when the driver moves the first and second driving operation systems 200 and 300 in the vertical direction, a signal related to a steering function may be generated.

The first and second driving operation systems 200 and 300 may move vertically by receiving power from a motor 600. When the first and second driving operation systems 200 and 300 are moved by the driving of the motor 600 in an autonomous driving mode, the driver may recognize that steering control is being performed in an autonomous driving situation.

As described above, a driving operation apparatus for a vehicle according to an exemplary embodiment included herein is a vehicle driving operation apparatus in which first and second driving operation systems 200 and 300, which are operated by the driver for steering, acceleration, and braking, are integrated into a single system together with a display unit 500 to form a module, allowing for a reduction in the number of components, which in turn enables weight reduction and cost savings, and minimizing the layout required for installation space. As a result, it may be possible to maximize the utilization of internal space.

Furthermore, according to an exemplary embodiment included herein, the first and second driving operation systems 200 and 300 are configured to move in opposite vertical directions in an interlinked manner during a steering operation by the driver. As a result, it may be possible to ensure safety during the steering operation.

Furthermore, according to an exemplary embodiment included herein, the first and second driving operation systems 200 and 300, which are driven in the vertical direction by the motor 600 in an autonomous driving situation, are configured to allow the driver to easily recognize, through the vertical movements thereof, that steering control of the vehicle is being smoothly performed in the autonomous driving mode. As a result, it may be possible to provide a sense of stability to passengers during the autonomous driving mode.

Although embodiments set forth herein have been described and illustrated in connection with various exemplary embodiments of the present disclosure, it will be apparent to those skilled in the art that various improvements and modifications may be made to the embodiments set forth herein without departing from the technical idea of the embodiments as defined by the appended claims.

What is claimed is:

1. A driving operation apparatus for a vehicle, the driving operation apparatus comprising:
a case module fixedly disposed while being connected to a vehicle panel unit;
first and second driving operation systems respectively disposed on left and right sides of the case module to be connected to the case module and configured to vertically move with respect to the case module and to allow a driver to perform steering, acceleration, and braking operations; and
a steering module disposed in the case module and configured to generate a signal related to a steering function based on that the steering operation is performed using the first and second driving operation systems.

2. The driving operation apparatus of claim 1, further comprising:
a panel extension fixedly coupled to the vehicle panel unit,
wherein the case module is fixedly coupled to the panel extension, and
wherein, by the panel extension, a clearance space is ensured between the vehicle panel unit and the first driving operation system and between the vehicle panel unit and the second driving operation system, allowing a driver’s hands to enter the clearance space to hold the first and second driving operation systems.

3. The driving operation apparatus of claim 1, further comprising:
a display unit coupled to a rear surface of the case module facing the driver.

4. The driving operation apparatus of claim 1, wherein the first and second driving operation systems are configured to move in opposite vertical directions to each other.

5. The driving operation apparatus of claim 1,
wherein the first and second driving operation systems are disposed on the left and right sides of the case module, respectively,
wherein, in a manual driving mode, based on that the first and second driving operation systems are located at a neutral position without moving vertically, the steering module generates a straight-driving signal,
wherein, in the manual driving mode, based on that the first driving operation system moves downward and the second driving operation system moves upward, the steering module generates a left-turn signal, and
wherein, in the manual driving mode, based on that the first driving operation system moves upward and the second driving operation system moves downward, the steering module generates a right-turn signal.

6. The driving operation apparatus of claim 1,
wherein guide grooves are disposed on the left and right sides of the case module to extend in a vertical direction along which the first and second driving operation systems move, and
wherein the first and second driving operation systems respectively comprise protrusions that are engaged into and move along the corresponding guide grooves.

7. The driving operation apparatus of claim 1, wherein the steering module comprises:
a gear unit rotatably disposed in the case module, engaged with the first and second driving operation systems, and configured with an odd number of gears engaged with each other so that the first and second driving operation systems move in opposite vertical directions to each other;
a first permanent magnet coupled to the gear unit; and
a first PCB coupled to the case module to face the first permanent magnet, the first PCB detecting a change in magnetic flux of the first permanent magnet during the steering operation of the driver and generating a signal related to the steering function.

8. The driving operation apparatus of claim 7, further comprising:
a steering return spring disposed with opposite end portions thereof connected to the case module and the gear unit to accumulate elastic force as the gear unit rotates during the steering operation and to return the rotated gear unit and the first and second driving operation systems connected thereto to a neutral position based on that a steering operation force is released.

9. The driving operation apparatus of claim 7, further comprising:
a motor coupled to one of the gears forming the gear unit,
wherein, in an autonomous driving mode, based on that the vehicle automatically performs steering control, a vehicle autonomous driving controller transmits a steering signal corresponding to the steering control to a driving operation system controller,
wherein the driving operation system controller transmits a motor drive signal in proportion to the steering signal to the motor,
wherein the first and second driving operation systems move vertically as the gear unit rotates by driving of the motor, and
wherein information indicating that steering control is being performed is provided to the driver in the autonomous driving mode through the vertical movement of the first and second driving operation systems.

10. The driving operation apparatus of claim 9,
wherein the first and second driving operation systems are disposed on the left and right sides of the case module, respectively,
wherein, in the autonomous driving mode, based on that the first and second driving operation systems remain at a neutral position without moving vertically, the vehicle is in a straight-driving state,
wherein, in the autonomous driving mode, based on that the motor is driven to move the first driving operation system downward and the second driving operation system upward, the vehicle is in a left-turn driving state, and
wherein, in the autonomous driving mode, based on that the motor is driven to move the first driving operation system upward and the second driving operation system downward, the vehicle is in a right-turn driving state.

11. The driving operation apparatus of claim 9, wherein, based on that an autonomous driving disable condition occurs in the autonomous driving mode, the motor is driven to alternately perform clockwise and counterclockwise rotations in succession, and
wherein, based on that the first and second driving operation systems receive a driving force from the motor and continuously move in the vertical direction, the vehicle is in a state in which autonomous driving is not available.

12. The driving operation apparatus of claim 1, wherein the first and second driving operation systems respectively comprise operation system gears and that are engaged with the steering module so that based on that the steering module operates, the first and second driving operation systems move along the operation system gears in opposite vertical directions to each other.

13. The driving operation apparatus of claim 1, wherein each of the first and second driving operation systems comprises:
a handle portion comprising an operation system gear, which is engaged with the steering module and extends in a vertical direction, the handle portion being configured to be held by the driver’s hand; and
handle covers coupled to upper and lower end portions of the handle portion, and
wherein each of the handle covers includes cover protrusions that protrude outward to prevent the driver’s hand from slipping off the handle portion.

14. The driving operation apparatus of claim 1, wherein each of the first and second driving systems further comprises:
a handle portion connected to the steering module and configured to be held by the driver’s hand;
a switch unit disposed on each handle portion to protrude outwardly from the handle portion, operated in response to a finger’s movement of the driver who holds the handle portion, and configured to move vertically along the handle portion in response to operation by the driver;
a slider located inside the handle portion, coupled to the switch unit, and moving vertically along the handle portion together with the switch unit;
a second permanent magnet coupled to the slider; and
a second PCB, disposed in the handle portion to face the second permanent magnet, the second PCB detecting a change in magnetic flux of the second permanent magnet based on that the switch unit is operated by the driver, and generating a signal related to an acceleration function or a signal related to a braking function.

15. The driving operation apparatus of claim 14,
wherein the slider comprises slider rods that protrude vertically along a movement direction of the slider, and
wherein the handle portion comprises rod insertion grooves into which the slider rods are respectively inserted and which guide a movement of the slider rods.

16. The driving operation apparatus of claim 14, further comprising:
switch return springs, each of which is disposed with opposite end portions thereof supported by the slider and the handle portion, the switch return springs being configured to accumulate elastic force based on that the slider is moved by operation of the switch unit, and to return the moved slider and the switch unit to a neutral position based on that an operation force applied to the switch unit is released.

17. The driving operation apparatus of claim 14, wherein the second PCB generates one of the signal related to the acceleration function and the signal related to the braking function based on that the switch unit moves upward along the handle portion, and generates a remaining one of the signal related to the acceleration function and the signal related to the braking function based on that the switch unit moves downward along the handle portion.

18. A driving operation apparatus for a vehicle, the driving operation apparatus comprising:
a case module disposed to be connected to a vehicle panel unit;
first and second driving operation systems disposed on left and right sides of the case module to be connected to the case module, being movable in a vertical direction relative to the case module, and configured so that based on that one of the first and second driving operation systems is operated, a remaining one of the first and second driving operation systems moves in an opposite vertical direction to each other; and
a switch unit disposed in each of the first and second driving operation systems and sliding vertically in response to a driver’s operation,
wherein, based on that the first and second driving operation systems move in the vertical direction, a signal related to a steering function is generated, and
wherein, based on that the switch unit moves in response to the driver’s operation, a signal related to an acceleration function or a signal related to a braking function is generated.

19. The driving operation apparatus of claim 18, wherein, in a manual driving mode, based on that the first and second driving operation systems are moved in the vertical direction in response to the driver’s operation, the signal related to a steering function is generated.

20. The driving operation apparatus of claim 18,
wherein the first and second driving operation systems are moved by receiving power from a motor in an autonomous driving mode, so that the driver recognizes that steering control is being performed in an autonomous driving situation.
